(19) United States
(12) Patent Application Publication
(10) Pub. No.: US 2025/0290739 A1
(43) Pub. Date: Sep. 18, 2025

(54) Actuator-Type Combination Square

(71) Applicant: Hultafors Group North America, Inc., Mequon, WI (US)

(72) Inventors: Nicholas C. Ackerman, West Allis, WI (US); Timothy J. Wojciechowski, Hubertus, WI (US)

(21) Appl. No.: 19/069,669

(22) Filed: Mar. 4, 2025

Related U.S. Application Data
(60) Provisional application No. 63/565,114, filed on Mar. 14, 2024.

(51) Int. Cl. G01B 3/56

(52) U.S. Cl. CPC G01B 3/566

(57) ABSTRACT

An adjustable combination square includes a head defining a channel and a longitudinally extending blade positioned for movement within the channel. The blade defines a slot along at least a portion of its length. An actuator arrangement is carried by the head, and is configured to releasably hold the blade in place relative to the head. The actuator is movably mounted to the head for movement between an operative position and a release position in response to application of a force in a direction transverse to the blade, which may be a pinch-type force exerted on a pair of actuator members incorporated in the actuator arrangement. The actuator arrangement may include a blade engagement member that is movably mounted to the head, and the actuator members act on the blade engagement member to selectively clamp the blade in position relative to the head.

### CROSS-REFERENCE TO RELATED APPLICATIONS

This patent application claims the benefit of U.S. provisional patent application Ser. No. 63/565,114 filed Mar. 14, 2024, the entire contents of which are hereby incorporated by reference.

### BACKGROUND AND SUMMARY

This application relates to construction and layout tools, and more particularly to an adjustable square typically known as a combination square.

In a typical prior art construction, a combination square includes a head having a channel within which a blade is longitudinally movable. The blade includes a slot within which the end of a clamping screw is received. The threads of the clamping screw are engaged with a rotatable knob. Rotation of the knob selectively moves the clamping screw between a clamping position in which an end of the clamping screw interacts with the slot of the blade to draw the blade against the head within the channel to lock the blade in position, and a release position in which the clamping force applied by the clamping screw is released in order to enable the blade to be moved within the channel relative to the head. While this construction provides adequate functionality, rotation of the knob can be cumbersome. In addition, the need to rotate the knob can make it difficult for the user to maintain the desired position of the blade relative to the head during the blade clamping operation.

The present invention provides an alternative, user-friendly approach to retaining the blade of a combination square in position relative to the head. In accordance with an aspect of the invention, an adjustable combination square includes a head defining a channel; a longitudinally extending blade positioned for longitudinal movement within the channel, with the blade defining a slot along at least a portion of its length; and an actuator arrangement carried by the head configured to releasably hold the longitudinally extending blade in place relative to the head. The actuator arrangement includes actuator members that are movably mounted to the head, for positioning the actuator arrangement in either an operative position or a release position in response to application of a force in a direction transverse to the blade. In the operative position, the actuator arrangement maintains the position of the blade relative to the head, and in the release position the actuator arrangement enables the blade to be moved within the channel relative to the head.

In one embodiment, the actuator arrangement includes a blade engagement member movably mounted to the head, and one or more manually engageable actuator members that act on the blade engagement member and are movably mounted to the head for moving the actuator arrangement between the operative position and the release position in response to application of the force in a direction transverse to the blade. The one or more manually engageable actuator members may be in the form of a pair of actuator tabs, a first one of which is accessible from a first side of the head and a second one of which is accessible from a second side of the head. The actuator tabs are movable toward each other in a direction transverse to the blade to place the actuator in the release position and are movable away from each other in a direction transverse to the blade to place the actuator in the operative position. The first and second actuator tabs may be movable relative to the head in any satisfactory manner, such as via sliding or pivoting movement toward and away from each other. A spring may be interposed between and act on the first and second actuator tabs to bias the actuator tabs away from each other.

The blade may define a longitudinal blade channel, and the blade engagement member includes a blade engagement portion located within the blade channel. The blade engagement member may be movable in an up-down direction relative to the blade in response to movement of the actuator tabs between the operative position and the release position. The blade engagement member and the actuator tabs include cooperating actuator structure that causes up-down movement of the blade engagement member in response to movement of the actuator tabs between the operative and release positions. The cooperating actuator structure may be in the form of adjacent sloped surfaces on the blade engagement member and on the first and second actuator tabs, wherein the sloped surfaces function to provide up-down movement of the blade engagement member in response to movement of the actuator tabs between the operative and release positions.

The invention also contemplates a method of operating an adjustable combination square, which includes a head defining a channel and a longitudinally extending blade positioned for longitudinal movement within the channel, substantially in accordance with the foregoing summary.

Other aspects, features and advantages of the invention will become apparent to those skilled in the art from the following detailed description and accompanying drawings. It should be understood, however, that the detailed description and specific examples, while indicating certain embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements can be several views, and in which:

FIG. 1 is an isometric view of a combination-type square in accordance with the present invention;

FIG. 2 front elevation view of the combination-type square of FIG. 1;

FIG. 3 is an exploded isometric view showing the components incorporated into the combination-type square of FIGS. 1 and 2;

FIG. 4 is an exploded isometric view showing the components of an actuator subassembly incorporated into the combination-type square of FIGS. 1-3;

FIG. 5 is an enlarged exploded isometric view showing components of the actuator subassembly incorporated into the combination-type square of FIGS. 1-4;

FIG. 6 is an isometric view showing the inside of a cover member incorporated into the actuator subassembly of FIG. 4;

FIG. 7 is an end elevation view of the combination-type square of FIGS. 1 and 2;

FIG. 8 is a section view taken along line 8-8 of FIG. 2, showing the actuator subassembly of FIGS. 4-6 in a release or inoperative position;

FIG. 9 is a section view taken along line 9-9 of FIG. 1, showing the actuator subassembly of FIGS. 4-6 in the release or inoperative position;

FIG. 10 is a section view similar to FIG. 8, showing the actuator subassembly of FIGS. 4-6 in an engaged or operative position; and

FIG. 11 is a section view similar to FIG. 9, showing the actuator subassembly of FIGS. 4-6 in the engaged or operative position.

In describing the representative embodiment of the invention that is illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected,” “attached,” or terms similar thereto are often used. They are not limited to direct connection but include connection through other elements where such connection would be recognized as being equivalent by those skilled in the art.

### DETAILED DESCRIPTION

The present invention and the various features and advantageous details thereof are explained more fully with reference to the non-limiting embodiments described in detail in the following description.

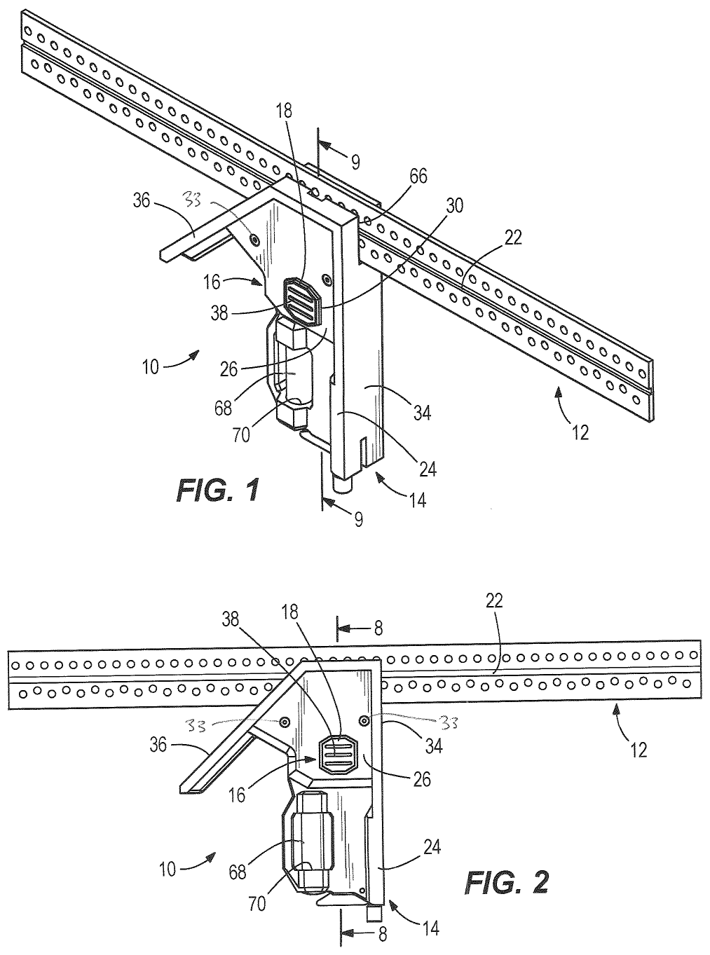

As shown in FIGS. 1 and 2, a representative combination square 10 in accordance with the present invention includes a longitudinally extending blade 12 coupled to a head 14 by way of an actuator arrangement 16, which includes first and second actuator tabs 18, 20. Blade 12 includes a recessed blade channel 22 extending longitudinally along at least a portion of its length. In a typical embodiment, the blade channel 22 extends throughout the entirety of the length of blade 12. Head 14 includes a body frame 24, and actuator arrangement 16 includes first and second cover members 26, 28 that are secured to opposite sides of body frame 24. The cover members 26, 28 have respective openings 30, 32 formed therein within which the actuator tabs 18, 20 are located. In the illustrated embodiment, the cover members 26, 28 are secured to the body frame 24 via mounting screws 33, although it is understood that any other satisfactory mounting arrangement may be employed.

Head 14, and more specifically as shown the body frame 24, defines a first planar edge 34 and a second planar edge 36. As shown in FIGS. 1 and 2, when the blade 12 is engaged with the head 14, the first edge 34 is oriented at a right angle, i.e. 90°, relative to the longitudinal axis of the blade 12, while the second edge 36 is oriented at a 450 angle relative to the longitudinal axis of the blade 12. In a manner to be explained, the actuator tabs 18, 20 of the actuator arrangement 16 are configured to operate using a pinch-type or squeeze-type motion, for selectively locking the blade 12 in a desired position relative to the head 14.

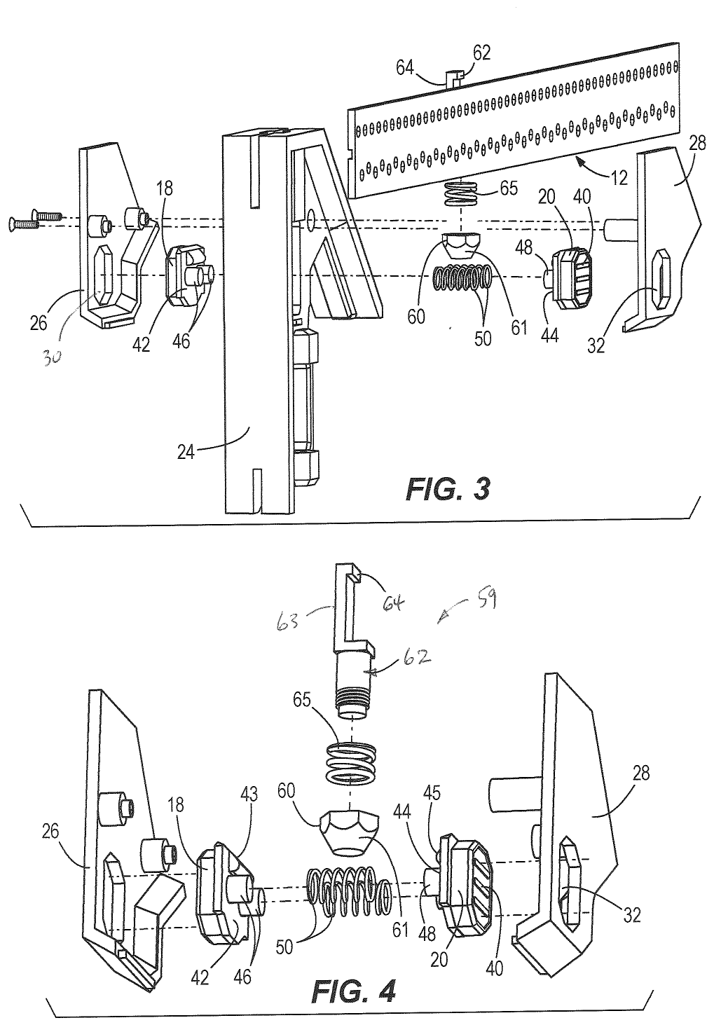

As shown in FIGS. 3-5, the actuator tabs 18, 20 are of similar mirrored construction, and include exterior surfaces 38, 40, as shown textured exterior surfaces. Upon assembly of the actuator assembly 16, the actuator tabs 18, 20 can be pressed inwardly towards one another as will be further described below. Additionally, the actuator tabs 18, 20 have respective interior surfaces 42, 44 that are provided with respective sloped upper cam surfaces 43, 45, as well as respective receivers 46, 48 configured to receive ends of a pair of transverse springs 50 extending between the actuator tabs 18, 20. The springs 50 automatically bias the actuator tabs 18, 20 away from one another until a user presses the actuator tabs 18, 20 together.

As noted previously, the actuator tabs 18, 20 have respective interior surfaces 42, 44. The interior surfaces 42, 44 of actuator tabs 18, 20 are configured to define stop surfaces for the actuator tabs 18, 20 when the actuator tabs 18, 20 are positioned within the openings 30, 32 of the cover members 26, 28. That is to say, the portion of the body of each actuator tab 18, 20 positioned within the opening 30, 32 has a shape that closely corresponds to the shape of the opening 30, 32, while the interior surfaces 42, 44 are configured to extend past the edges of the openings 30, 32 and abut the interior surfaces of the cover member 26, 28 adjacent the openings 30, 32 when the actuator tabs 18, 20 are moved outwardly apart from each other under the influence of the springs 50. This relationship of the interior surfaces 42, 44 relative to the openings 30, 32 is illustrated in FIG. 6.

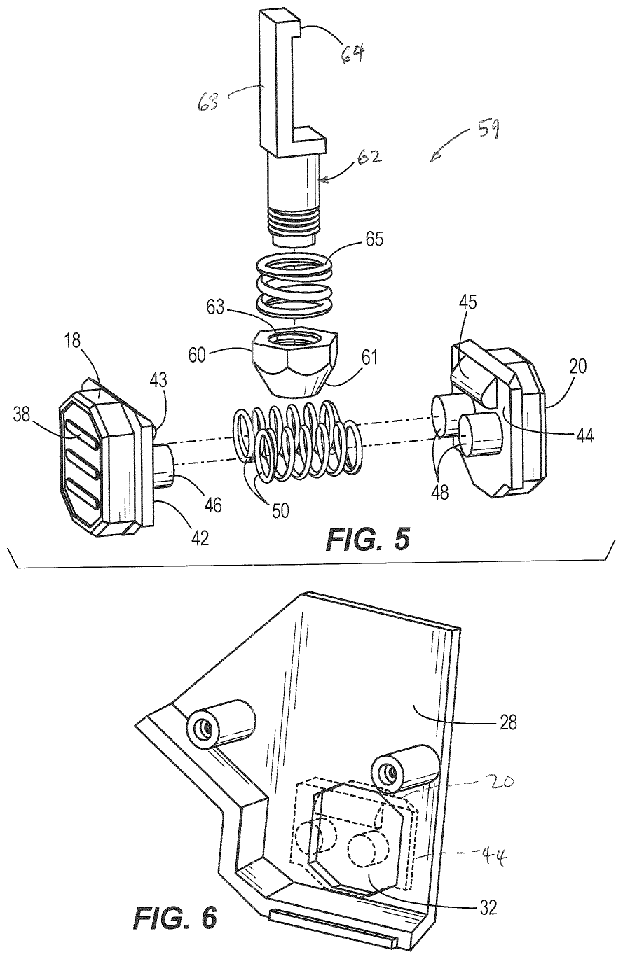

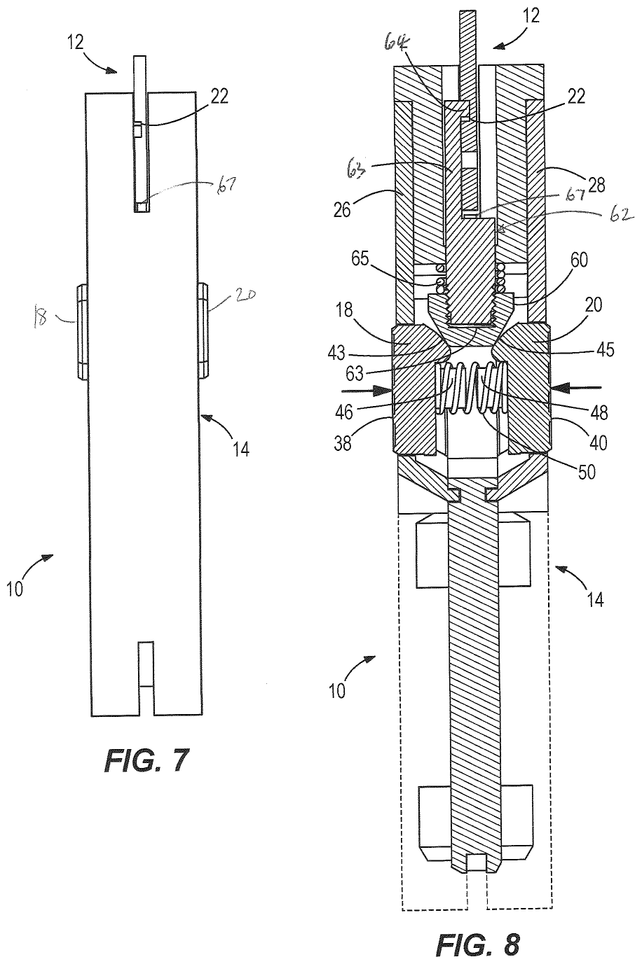

With reference to FIGS. 4 and 5, the actuator arrangement 16 of combination square 10 includes a blade engagement subassembly 59 that includes a cam member 60 having a sloped side surface 61, as well as a post 62. In the illustrated embodiment, the post 62 is provided with external threads at its lower end, and the cam member 60 is provided with internal threads adapted to engage the external threads at the lower end of post 62. It is understood, however, that any satisfactory form of connection of cam member 60 to post 62 may be employed, or alternatively that cam member 60 and post 62 may be formed integrally with each other. Post 62 extends through a passage defined by a spring 65, and the lower end of spring 65 bears against the upper surface of cam member 60.

The post 62 includes an upper extension 63 having a blade engagement tab 64 extending laterally therefrom. In assembly, the blade engagement tab 64 is configured to be engaged with the blade channel 22 when the blade 12 is positioned within a channel 66 defined by the body frame 24. In a manner as is known, the channel 66 is configured such that the lower portion of the blade 12 and the blade channel 22 is contained within the channel 66 defined by the body frame 24.

As will further be described, the actuator tabs 18, 20 and the spring 50 enable the actuator arrangement 16 to move between an engaged position in which the blade 12 is locked in place relative to the head 14, and a disengaged position in which the blade 12 is moveable relative to the head 14.

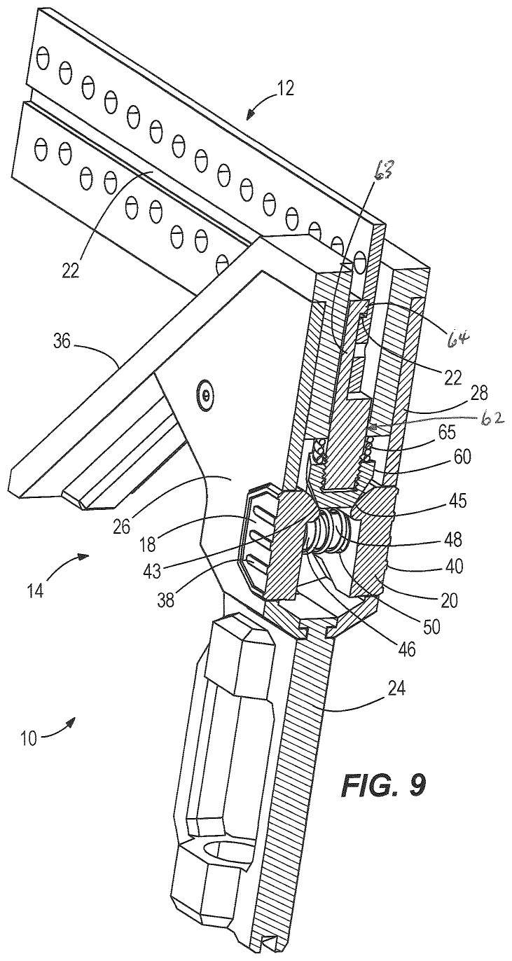

Movement of the combination square 10 to the disengaged position in which the blade 12 is moveable relative to the head 14 will be described with reference to FIGS. 8 and 9. When a user wishes to adjust the position of the blade 12, the user presses the actuator tabs 18, 20 inwardly towards one another. This movement of actuator tabs 18, 20 is against the spring force of the springs 50, such that the springs 50 are compressed. When the actuator tabs 18, 20 are moved towards one another in this manner, the upper cam surfaces 43, 45 of actuator tabs 18, 20 engage with the sloped side surface 61 of the cam member 60. Such inward movement of actuator tabs 18, 20 thus drives the cam member 60 in an upward direction, resulting in upward movement of post 62 within a passage defined by body frame 24. Such upward movement of post 62 results in compression of the spring 65, which bears between the upper surface of cam member 60 and a facing bearing surface defined by the body frame 24. Blade engagement tab 64 is likewise moved upwardly so that the blade engagement tab 64 moves the blade 12 out of contact with a clamping surface 67 defined by the blade channel 22. Once this occurs, the blade 12 can be moved freely relative to the head 14 within the channel 66. The body frame 24 is configured to allow a user to receive the head 14 within the user's hand such that the user's thumb engages one of the actuator tabs 18, 20 and one of the opposing fingers may engage the other of the first and second actuator tabs 18, 20 in a pinching motion to enable adjustments of the blade 12 relative to the head 14.

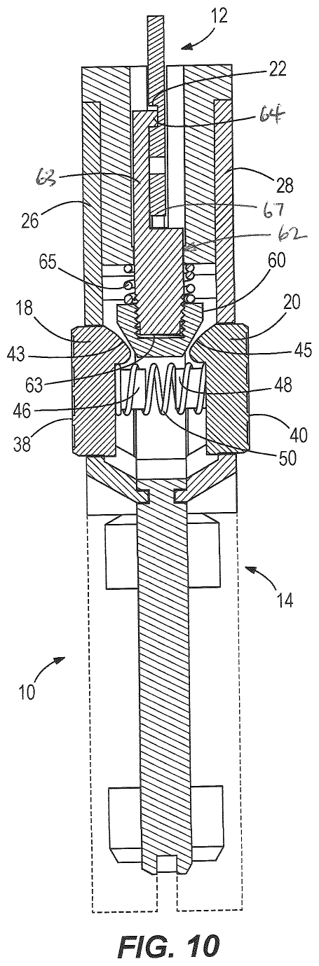

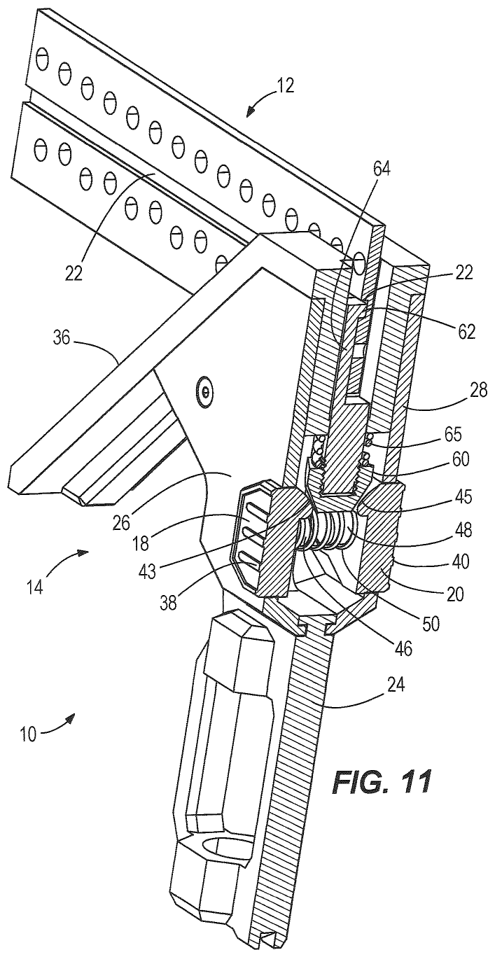

Movement of the combination square 10 to the engaged position in which the blade 12 is locked in position relative to the head 14 will be described with reference to FIGS. 10 and 11. When the user wishes to lock the position of the blade 12, the user releases engagement with the actuator tabs 18, 20. When the actuator tabs 18, 20 are released, the spring 50 biases the actuator tabs 18, 20 apart from one another. As a result, the sloped upper cam surfaces 43, 45 of actuator tabs 18, 20 are moved out of engagement with the sloped surface 61 of cam member 60. This allows full downward movement of post 64 within the passage defined by body frame 24 under the influence of spring 65. With blade engagement tab 64 being engaged with the edge of the blade channel 22, the blade 12 is forced downwardly so that its lower edge bears against the clamping surface 67 defined by body frame 24, such that frictional engagement between the lower edge of blade 12 and clamping surface 67 prevents movement of the blade 12 relative to the head 14.

While not related to the present invention, the body frame 24 of combination square 10 may optionally contain a level vial 68 within an opening 70 located near an end opposite the blade 12.

Blade 12 may be constructed from a single piece of extruded metal such as, for example, aluminum or steel, and stamped or printed with measurement graduations (not shown) along the face of the blade 12. The body frame 24 of the head 14 may be constructed from a single piece of cast and/or milled metal such as, for example, aluminum, steel or zinc, and the cover members 26, 28 may be constructed from plastic, such as injection molded plastic. Alternatively, the body frame 24 and the cover members 26, 28 may be formed together of a single piece of metal or plastic. The actuator tabs 18, 20 may similarly be constructed from plastic, such as injection molded plastic. It is understood, however, that other materials and forming methods may be employed for the described components.

Although the best mode contemplated by the inventor of carrying out the present invention is disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments. It is also understood that the invention disclosed and defined herein extends to all alternative combinations of two or more of the individual features mentioned or evident from the text and/or drawings. All of these different combinations constitute various alternative aspects of the present invention.

We claim:

1. An adjustable combination square comprising:
a head defining a channel;
a longitudinally extending blade positioned for longitudinal movement within the channel, wherein the blade defines a slot along at least a portion of its length; and
an actuator carried by the head configured to releasably hold the longitudinally extending blade in place relative to the head, wherein the actuator is movably mounted to the head for movement between an operative position and a release position in response to application of a force in a direction transverse to the blade, wherein in the operative position the actuator maintains the position of the blade relative to the head and in the release position the actuator enables the blade to be moved within the channel relative to the head.

2. The adjustable combination square of claim 1, wherein the actuator comprises a blade engagement member movably mounted to the head, and one or more manually engageable actuator members that act on the blade engagement member and are movably mounted to the head between the operative position and the release position in response to application of the force in a direction transverse to the blade.

3. The adjustable combination square of claim 2, wherein the one or more manually engageable actuator members comprises a pair of actuator tabs, a first one of which is accessible from a first side of the head and a second one of which is accessible from a second side of the head, wherein the actuator tabs are movable toward each other in a direction transverse to the blade to place the actuator in the release position and are movable away from each other in a direction transverse to the blade to place the actuator in the operative position.

4. The adjustable combination square of claim 3, wherein the first and second actuator tabs are pivotably mounted to the head.

5. The adjustable combination square of claim 3, further comprising a spring interposed between and acting on the first and second actuator tabs to bias the actuator tabs away from each other.

6. The adjustable combination square of claim 2, wherein the blade defines a longitudinal blade channel, and wherein the blade engagement member includes a blade engagement portion located within the blade channel, wherein the blade engagement member is movable in an up-down direction relative to the blade in response to movement of the one or more manually engageable actuator members between the operative position and the release position.

7. The adjustable combination square of claim 6, wherein the one or more manually engageable actuator members comprises a pair of actuator tabs, a first one of which is accessible from a first side of the head and a second one of which is accessible from a second side of the head, wherein the actuator tabs are movable toward each other in a direction transverse to the blade to place the actuator in the release position and are movable away from each other in a direction transverse to the blade to place the actuator in the operative position, and wherein the blade engagement member and the first and second actuator tabs include cooperating actuator structure that causes up-down movement of the blade engagement member in response to movement of the actuator tabs between the operative and release positions.

8. The adjustable combination square of claim 7, wherein the first and second actuator tabs are pivotably mounted to the head, and wherein the cooperating actuator structure comprises adjacent sloped surfaces on the blade engagement member and on the first and second actuator tabs, wherein the sloped surfaces function to provide up-down movement of the blade engagement member in response to movement of the actuator tabs between the operative and release positions.

9. An adjustable combination square comprising:
a head defining a channel;
a longitudinally extending blade positioned for longitudinal movement within the channel, wherein the blade defines a slot along at least a portion of its length; and
an actuator carried by the head configured to releasably hold the longitudinally extending blade in place relative to the head, wherein the actuator comprises a blade retainer arrangement and a pair of actuator tabs movably mounted to the head, wherein the actuator tabs are manually movable toward each other to a release position in which the blade retainer arrangement enables movement of the blade relative to the head within the channel, and are movable away from each other to an operative position in which the blade retainer arrangement maintains the position of the blade relative to the head.

10. The adjustable combination square of claim 9, wherein the a first one of the actuator tabs is accessible from a first side of the head and a second one of the actuator tabs is accessible from a second side of the head.

11. The adjustable combination square of claim 10, wherein the first and second actuator tabs are pivotably mounted to the head.

12. The adjustable combination square of claim 10, further comprising a spring interposed between and acting on the first and second actuator tabs, wherein the spring is operable to bias the actuator tabs away from each other to the operative position.

13. The adjustable combination square of claim 10, wherein the blade defines a longitudinal blade channel, and wherein the blade retainer arrangement includes a blade engagement portion located within a channel defined by the blade, wherein the blade retainer arrangement is movable in an up-down direction relative to the blade in response to movement of the actuator tabs between the operative position and the release positions.

14. The adjustable combination square of claim 13, wherein the blade retainer arrangement and the first and second actuator tabs include cooperating actuator structure that causes up-down movement of the blade retainer arrangement in response to movement of the actuator tabs between the operative and release positions.

15. The adjustable combination square of claim 14, wherein the first and second actuator tabs are pivotably mounted to the head, and wherein the cooperating actuator structure comprises adjacent sloped surfaces on the blade retainer arrangement and on the first and second actuator tabs, wherein the sloped surfaces function to provide up-down movement of the blade retainer arrangement in response to movement of the actuator tabs between the operative and release positions.

16. A method of operating an adjustable combination square, wherein the combination square includes a head defining a channel and a longitudinally extending blade positioned for longitudinal movement within the channel, comprising selectively locking the blade in position relative to the head by operation of an actuator carried by the head, wherein the actuator is movably mounted to the head for movement between an operative position and a release position in response to application of a force in a direction transverse to the blade, wherein in the operative position the actuator maintains the position of the blade relative to the head and in the release position the actuator enables the blade to be moved within the channel relative to the head.

17. The method of claim 16, wherein the actuator comprises a blade engagement member movably mounted to the head, and one or more manually engageable actuator members that act on the blade engagement member and are movably mounted to the head between the operative position and the release position in response to application of the force in a direction transverse to the blade.

18. The method of claim 17, wherein the one or more manually engageable actuator members comprises a pair of actuator tabs, a first one of which is accessible from a first side of the head and a second one of which is accessible from a second side of the head, wherein selectively locking the blade in position relative to the head is carried out by movement of the actuator tabs toward each other in a direction transverse to the blade to place the actuator in the release position and movement of the actuator tabs away from each other in a direction transverse to the blade to place the actuator in the operative position.

19. The method of claim 18, wherein the act of moving the actuator tabs away from each other is carried out via a spring interposed between and acting on the first and second actuator tabs that biases the actuator tabs away from each other.

20. The method of claim 19, wherein the engagement member includes a blade engagement portion located within a channel defined by the blade, wherein the blade engagement member is movable in an up-down direction relative to the blade in response to movement of the one or more manually engageable actuator members between the operative position and the release positions.

21. The method of claim 20, wherein the one or more manually engageable actuator members comprises a pair of actuator tabs, a first one of which is accessible from a first side of the head and a second one of which is accessible from a second side of the head, wherein the actuator tabs are movable toward each other in a direction transverse to the blade to place the actuator in the release position and are movable away from each other in a direction transverse to the blade to place the actuator in the operative position, and wherein the blade engagement member and the first and second actuator tabs include cooperating actuator structure that causes up-down movement of the blade engagement member in response to movement of the actuator tabs between the operative and release positions, wherein the cooperating actuator structure comprises adjacent sloped surfaces on the blade engagement member and on the first and second actuator tabs, wherein the sloped surfaces function to provide up-down movement of the blade engagement member in response to movement of the actuator tabs between the operative and release positions.
